(19) United States
(12) Patent Application Publication
(10) Pub. No.: US 2025/0284171 A1
(43) Pub. Date: Sep. 11, 2025

(54) ELECTRO-OPTIC DISPLAYS WITH COLOR FILTER ARRAYS FOR REDUCING VISIBLE TEXTURE PATTERNS IN DISPLAYED IMAGES

(71) Applicant: E INK CORPORATION, Billerica, MA (US)

(72) Inventor: Dirk HERTEL, Quincy, MA (US)

(21) Appl. No.: 19/072,601

(22) Filed: Mar. 6, 2025

Related U.S. Application Data
(60) Provisional application No. 63/561,909, filed on Mar. 6, 2024.

(51) Int. Cl. G02F 1/1677; G02F 1/167; G02F 1/1675; G02F 1/16757; G02F 1/16766

(52) U.S. Cl. CPC G02F 1/1677; G02F 1/167; G02F 1/16757; G02F 1/16766; G02F 2001/1678

(57) ABSTRACT

A color electro-optic display includes a layer of electro-optic material having a light-transmissive electrode on a viewing side, an array of pixel electrodes on an opposite side, and a color filter array (CFA) on the viewing side. The pixel electrodes drive selected portions of the electro-optic material between white and black optical states. The CFA includes an array of pixels, each of which has at least three color filter elements. Each color filter element is aligned with a different one of the pixel electrodes such that the color of any color filter element is visible when the adjacent portion of the electro-optic material is driven to the white optical state, and not visible when driven to the black optical state. The colors of the color filter elements have the same lightness or a lightness difference no greater than 10 L* to substantially eliminate visible CFA texture patterns in displayed images.

### CROSS-REFERENCE TO RELATED APPLICATIONS

This application claims priority from U.S. Provisional Patent Application No. 63/561,909 filed on 6 Mar. 2024 entitled Electro-Optic Displays with Color Filter Arrays for Reducing Visible Texture Patterns in Displayed Images, which is hereby incorporated by reference in its entirety.

### BACKGROUND

This invention relates to electro-optic displays and color filter arrays used in such displays configured to reduce visible texture patterns in displayed images.

The term “electro-optic”, as applied to a material or a display, is used herein in its conventional meaning in the imaging art to refer to a material having at least first and second display states differing in at least one optical property, the material being changed from its first to its second display state by application of an electric field to the material. Although the optical property is typically color perceptible to the human eye, it may be another optical property, such as optical transmission, reflectance, or luminescence or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven by means of an addressing pulse of finite duration to assume either its first or second display state after the addressing pulse has terminated, which state will persist for at least several times, e.g., at least four times, the minimum duration of the addressing pulse required to change the state of the display element. It is shown, e.g., in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” is used herein to cover both bistable and multi-stable displays.

There are several types of electro-optic displays, one of which is a rotating bichromal member display as described, e.g., in U.S. Pat. Nos. 5,808,783; 5,777,782; 5,760,761; 6,054,071; 6,055,091; 6,097,531; 6,128,124; 6,137,467; and 6,147,791. (Although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) that have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, e.g., an electrochromic medium in the form of a nanochromic film comprising an electrode formed at least in part from a semi-conducting metal oxide and a plurality of dye molecules capable of reversible color change attached to the electrode; see, e.g., O'Regan, B., et al., Nature 1991, 353, 737; and Wood, D., Information Display, 18 (3), 24 (March 2002). See also Bach, U., et al., Adv. Mater., 2002, 14 (11), 845. Nanochromic films of this type are also described, e.g., in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). U.S. Pat. No. 7,420,549 shows how such electro-wetting displays can be made bistable.

Another type of electro-optic display is a particle-based electrophoretic display (EPD), in which a plurality of charged particles move through a suspending fluid under the influence of an electric field. Electrophoretic displays have been the subject of intense research and development for a number of years. Such displays can have attributes of good brightness and contrast, wide viewing angles, state bistability, and low power consumption compared with liquid crystal displays.

As noted above, electrophoretic media require the presence of a suspending fluid. In most prior art electrophoretic media, this suspending fluid is a liquid, but electrophoretic media can be produced using gaseous suspending fluids; see, e.g., Kitamura, T., et al., “Electrical toner movement for electronic paper-like display”, IDW Japan, 2001, Paper HCS1-1, and Yamaguchi, Y, et al., “Toner display using insulative particles charged triboelectrically”, IDW Japan, 2001, Paper AMD4-4). See also European Patent Applications 1,429,178; 1,462,847; and 1,482,354; and International Applications WO 2004/090626; WO 2004/079442; WO 2004/077140; WO 2004/059379; WO 2004/055586; WO 2004/008239; WO 2004/006006; WO 2004/001498; WO 03/091799; and WO 03/088495. Such gas-based electrophoretic media appear to be susceptible to the same types of problems due to particle settling as liquid-based electrophoretic media, when the media are used in an orientation that permits such settling, e.g., in a sign where the medium is disposed in a vertical plane. Indeed, particle settling appears to be a more serious problem in gas-based electrophoretic media than in liquid-based ones since the lower viscosity of gaseous suspending fluids as compared with liquid ones allows more rapid settling of the electrophoretic particles.

As noted above, electrophoretic media require the presence of a fluid. In most prior art electrophoretic media, this fluid is a liquid, but electrophoretic media can be produced using gaseous fluids; see, e.g., Kitamura, T., et al., Electrical toner movement for electronic paper-like display, IDW Japan, 2001, Paper HCS1-1, and Yamaguchi, Y., et al., Toner display using insulative particles charged triboelectrically, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, e.g., in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see, e.g., U.S. Pat. No. 7,002,728;
(b) Capsules, binders and encapsulation processes; see, e.g., U.S. Pat. Nos. 6,922,276 and 7,411,719;
(c) Microcell structures, wall materials, and methods of forming microcells; see, e.g., U.S. Pat. Nos. 7,072,095 and 9,279,906;
(d) Methods for filling and sealing microcells; see, e.g., U.S. Pat. No. 7,715,088 and U.S. Patent Application Publication No. 2002/0188053;
(e) Films and sub-assemblies containing electro-optic materials; see, e.g., U.S. Pat. Nos. 6,982,178 and 7,839,564;
(f) Backplanes, adhesive layers and other auxiliary layers and methods used in displays; see, e.g., U.S. Pat. Nos. 7,116,318 and 7,535,624;
(g) Color formation and color adjustment; see, e.g., U.S. Pat. Nos. 7,075,502 and 7,839,564;
(h) Methods for driving displays; see, e.g., U.S. Pat. Nos. 7,012,600 and 7,453,445;
(i) Applications of displays; see, e.g., U.S. Pat. Nos. 7,312,784 and 8,009,348; and
(j) Non-electrophoretic displays, as described in U.S. Pat. No. 6,241,921 and U.S. Patent Applications Publication No. 2015/0277160; and applications of encapsulation and microcell technology other than displays; see, e.g., U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed EPD, in which the electrophoretic medium comprises a plurality of discrete droplets of an electrophoretic fluid and a continuous phase of a polymeric material, and that the discrete droplets of electrophoretic fluid within such a polymer-dispersed EPD may be regarded as capsules or microcapsules even though no discrete capsule membrane is associated with each individual droplet; see, e.g., U.S. Pat. No. 6,866,760. Accordingly, for purposes of the present application, such polymer-dispersed electrophoretic media are regarded as sub-species of encapsulated electrophoretic media.

A related type of EPD is a so-called microcell EPD. In a microcell EPD, the charged particles and the fluid are not encapsulated within microcapsules, but instead are retained within a plurality of cavities formed within a carrier medium, typically a polymeric film. See, e.g., U.S. Pat. Nos. 6,672,921 and 6,788,449.

Electrophoretic media are often opaque (since, e.g., in many electrophoretic media, the particles substantially block transmission of visible light through the display) and operate in either a light-absorptive or a light-reflective mode. However, electrophoretic devices can also be made to operate in a so-called “shutter mode,” in which one display state is substantially opaque and one is substantially light-transmissive. See, e.g., the aforementioned U.S. Pat. Nos. 6,130,774 and 6,172,798, and 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. In particular, when this “shutter mode” electrophoretic device is constructed on a transparent substrate, it is possible to regulate transmission of light through the device.

An encapsulated or microcell electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques.) Thus, the resulting display can be flexible. Further, because the display medium can be printed (using a variety of methods), the display itself can be made inexpensively.

Other types of electro-optic media may also be used in the displays of the present invention.

Many types of electro-optic media are essentially monochrome, in the sense that any given medium has two extreme optical states (a white state (WS) and a dark state (DS)) and a range of gray levels lying between the two extreme optical states. The two extreme optical states need not be black and white. For example, one extreme optical state can be white and the other dark blue, so that the intermediate gray levels will be varying shades of blue, or one extreme optical state can be red and the other blue, so that the intermediate gray levels will be varying shades of purple.

There is today an increasing demand for full color displays, even for small, portable displays. For instance, most displays on cellular telephones today are full color. To provide a full color display using monochrome media, it is either necessary to utilize a color filter array (CFA) where the display can be viewed through the CFA, or to provide areas of different electro-optic media capable of displaying different colors adjacent one another.

CFAs have been known to produce undesirable visible texture patterns associated with the arrangement of CFA filter stripes. A need exists for an improved CFA for electro-optic displays that reduces such visible texture patterns.

### SUMMARY

A color electro-optic display according to one aspect of the invention includes a layer of electro-optic material having a viewing side for facing a viewer, a light-transmissive electrode on the viewing side of the layer of electro-optic material, an array of pixel electrodes on an opposite side on the layer of electro-optic material, and a color filter array disposed on the viewing side of the layer of electro-optic material. The pixel electrodes are each independently addressable to apply a driving voltage to an adjacent portion of the layer of electro-optic material associated therewith to drive such portion of the electro-optic material between a first substantially white optical state and a second substantially black or dark optical state at the viewing side of the electro-optic layer. The color filter array comprises an array of pixels, each of which includes at least three color filter elements or subpixels. Each of the color filter elements has a different color, and is aligned with a different one of the pixel electrodes such that the color of any color filter element is visible to the viewer when the pixel electrode aligned with that color filter element drives an adjacent portion of the electro-optic material to the substantially white optical state. The color of a color filter element is not visible to the viewer when the pixel electrode aligned with that color filter element drives an adjacent portion of the electro-optic material to a substantially black optical state. The colors of the color filter elements in the color filter array are configured to have the same lightness or a lightness difference no greater than 10 L* to substantially eliminate visible color filter array texture patterns in displayed images.

In one or more embodiments, the colors of the color filter elements in the color filter array have a luminance contrast of less than 1.6.

In one or more embodiments, the colors of the color filter elements in the color filter array are red, green, and blue.

In one or more embodiments, the colors of the color filter elements in the color filter array have lightness values between about 45 L* and about 55 L*.

In one or more embodiments, the layer of electro-optic material is monochrome.

In one or more embodiments, the layer of electro-optic material comprises an encapsulated electrophoretic medium. The encapsulated electrophoretic medium may comprise an electrophoretic medium encapsulated in microcapsules or microcups.

In one or more embodiments, the layer of electro-optic material comprises charged pigment particles dispersed in a non-polar solvent. In one or more embodiments, the charged pigment particles comprise black and white pigment particles. In other embodiments, the charged pigment particles comprise blue and white pigment particles.

In one or more embodiments, the layer of electro-optic material is bistable.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a schematic cross-sectional view of a representative electrophoretic display in which the electrophoretic medium is encapsulated in microcapsules.

FIG. 1B is a schematic cross-sectional view of a representative electrophoretic display in which the electrophoretic medium is encapsulated in microcells.

FIG. 1C is a schematic cross-sectional view of a representative electrophoretic display including an electrophoretic layer containing oppositely charged black and white particles coupled to a CFA between the electrophoretic layer and the viewer.

FIG. 1D is a representative red-green-blue-white (RBGW) color filter array pattern that can be used with a CFA-enabled color electrophoretic display. The dashed line defines a “pixel” for the purposes of defining a pixel in an image. Each pixel of the RGBW CFA includes an independently controllable red, green, and blue partially-transmissive filter portion, known as a “subpixel”. A clear (a.k.a. white) subpixel helps to improve white and light colors in an image. Below each subpixel is an independently-controllable pixel electrode.

FIG. 1E is an exemplary red-green-blue (RBG) color filter array pattern that can be used with a CFA-enabled color electrophoretic display. The dashed line defines a “pixel” for the purposes of defining a pixel in an image. Each pixel of the RGB CFA includes an independently controllable red, green, and blue partially-transmissive filter portion, known as a subpixel. A portion around each subpixel is clear (a.k.a., partial fill CFA) in order to improve white and light colors in an image, but with higher overall resolution than in FIG. 1D. Below each subpixel is an independently-controllable pixel electrode.

FIG. 2A shows the subpixel arrangement of an exemplary CFA. FIG. 2B shows the reflected luminance of the CFA.

FIGS. 3A and 3B are graphs showing CIELAB colors reflected by CFA RGB subpixels in b* vs. a* and L* vs. C* diagrams, respectively, as a function of CFA print ink concentration. (L* indicates lightness, C* represents chroma, a* is the red/green coordinate, and b* is the yellow/blue coordinate.)

FIG. 4 is a graph showing lightness L* of RGB subpixels on a white state versus relative CFA printed ink amounts.

FIGS. 5A, 5B, 5C, and 5D show Tables 1, 2, 3, and 4, respectively.

### DETAILED DESCRIPTION

According to one aspect of the invention, a reflective electro-optic display includes a CFA having filter primary colors of matched lightness to reduce visible texture patterns in displayed images.

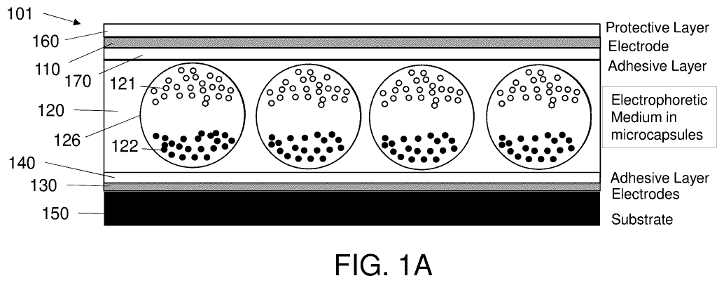

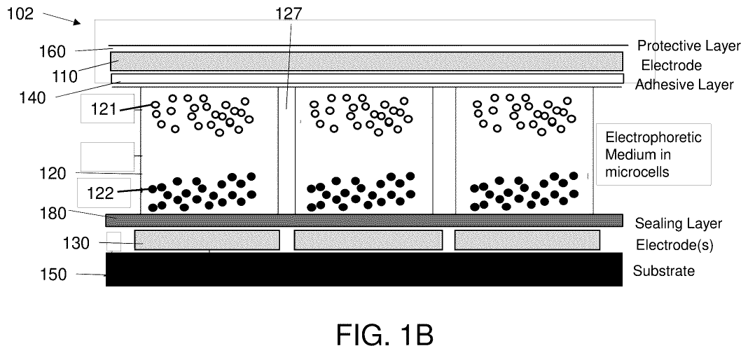

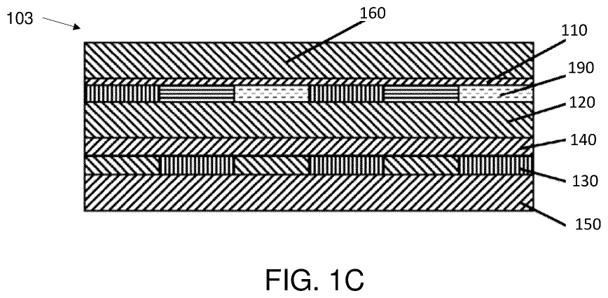

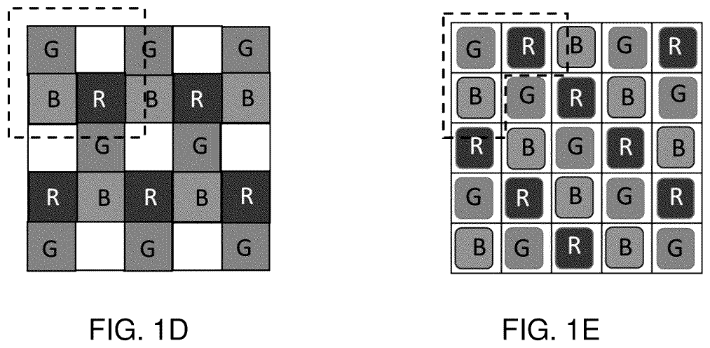

FIGS. 1A and 1B illustrate representative electrophoretic displays 101, 102 in which the electrophoretic medium is encapsulated in microcapsules and microcells, respectively. FIG. 1C shows an electrophoretic display 103 including a CFA 190. As shown, each electrophoretic display 101, 102, 103 includes a top transparent electrode 110, an electrophoretic medium 120, and a bottom electrode layer 130 comprising pixel electrodes of an active matrix of pixels controlled, e.g., with thin film transistors (TFT). As shown in FIGS. 1A and 1B, the electrophoretic media 120 of displays 101, 102 includes oppositely charged white and black particles 121, 122. The CFA display 103 of FIG. 1C also includes an encapsulated electrophoretic medium 120 with black and white oppositely-charged particles. FIG. 1D is an exemplary RBGW color filter array pattern that can be incorporated in the CFA display 103. The colored elements may be provided directly on the top transparent electrode 110, which may be, for example, indium-tin-oxide (ITO). Such CFA films are available from Toppan Printing (Japan). Alternatively, the color filter elements may be applied to the electrophoretic media 120 with an ink-jet or other precision printing process. See U.S. Pat. No. 10,209,556. In FIGS. 1D and 1E, the dashed lines define a “pixel” for the purposes of defining a pixel in an image. In FIG. 1D, each pixel of the RGBW CFA includes independently-controllable red, green, blue, and clear subpixels to improve white and render lighter as well as darker colors in an image. In FIG. 1E, each pixel of the RGB CFA includes independently-controllable red, green, and blue subpixels with a portion around each subpixel being clear (a.k.a., partial fill CFA) in order to improve white and light colors in an image. In practice CFA patterns of FIG. 1E are preferred over the patterns of FIG. 1D because each image pixel is slightly smaller and thus a higher resolution can be achieved for the same number of pixel electrodes per inch (PPI), typically between 100 and 400 PPI, more commonly between 150 and 300 PPI.

The electrophoretic medium 120 is typically compartmentalized such by microcapsules 126 or the walls of microcells 127. An optional adhesive layer 140 can be disposed adjacent any of the layers, however, it is typically adjacent an electrode layer 110 or 130. There may be more than one adhesive layer 140 in a given electrophoretic display, however only one layer is more common. The entire display stack is typically disposed on a substrate 150, which may be rigid or flexible. The displays typically also include a protective layer 160, which may simply protect the top electrode 110 from damage, or it may envelop the entire display to prevent ingress of water, etc. The displays may also include sealing layers 180 as needed. The adhesive layer 140 may include a primer component to improve adhesion to the electrode layer 110, or a separate primer layer may be used. The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

Although improvements have been achieved with CFA-enabled displays, it has been found that CFAs can produce visible texture associated with the arrangement of the CFA filters, e.g., RGB filter stripes in the horizontal or vertical orientations producing a texture of horizontal or vertical lines. The visibility of these lines depends on the resolution of the display and the viewing distance, both in relation to the luminous contrast sensitivity function (CSF) of the human visual system (HVS). For example, if the display has a TFT backplane with a resolution of 300 pixels per inch (PPI) and a CFA with three filter primaries (RGB), then its native subpixel resolution is 300 PPI, but its color resolution is only 100 PPI. If the display is viewed at a viewing distance of 12 inches, the 300 PPI subpixel resolution corresponds to a spatial frequency of 31.4 cycles/degree on the viewer's retina, and the 100 PPI color resolution corresponds to a spatial frequency of 10.5 cycles/degree, which is close to the maximum luminous contrast sensitivity. As a result, CFA patterns can be highly visible, especially when displaying white state or light neutral gray colors.

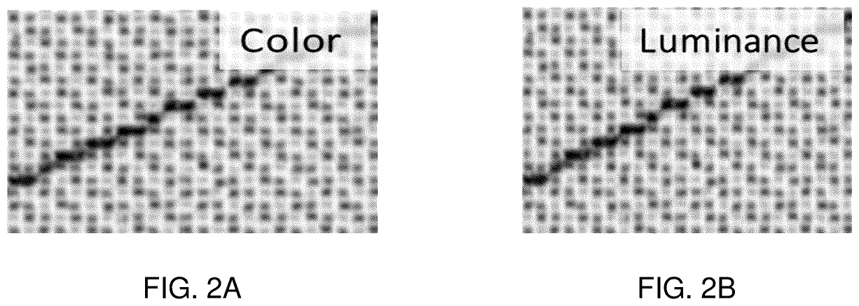

Several methods are known in the art for reducing the visual impact of CFA texture patterns, including increasing the display resolution beyond the visibility limit of the CSF and finding CFA arrangements with less visible texture. Increasing the resolution of the CFA requires a corresponding increase of the TFT backplane resolution and is only effective if high spatial frequencies at or beyond the retinal color resolution are reached, which corresponds to a color resolution of 447 PPI at a 12 inch viewing distance and 326 PPI at 18 inches, with corresponding subpixel resolutions of three times those resolutions. Examples of such displays include the Apple Retina® display, with a 26 μm subpixels corresponding to a subpixel resolution of 978 PPI and a color resolution of 326 PPI. However, current electrophoretic color displays with CFAs reach subpixel resolutions of only about 300 PPI because higher resolutions increase blooming and optical crosstalk. This makes modified CFA subpixel arrangements the preferred method of mitigating texture using CFA patterns with staggered arrangements of short-stripe RGB or Bayer-like RGB patterns. However, in each of these CFA patterns, instead of being in horizontal or vertical directions, the texture lines are tilted from the horizontal and vertical directions at angles corresponding to the CFA arrangements, e.g., at 45 degrees for a staggered RGB pattern shown in FIG. 2A. If the reflected luminance differs between the red, green, and blue subpixels as illustrated in FIG. 2B, the texture is highly visible because the luminance channel of human vision is most sensitive to texture. In addition, some CFA arrangements can make the rendering of text and images more difficult, leading to unwanted text and image artifacts. Accordingly, there is a need for improved CFAs for electro-optic displays that reduce visible texture patterns.

According to one aspect of the invention, a reflective electro-optic display includes a CFA having CFA subpixels of matched lightness to reduce visible texture patterns in displayed images. It has been found that reducing the luminance contrast among the CFA subpixels reduces the visibility of CFA texture. Reducing luminance contrast is less costly than other ways of mitigating texture such as modifying CFA patterns or increasing subpixel resolution. The CFA design can thereby be optimized for best text and image rendering rather than texture mitigation.

In accordance with one or more embodiments, Kubelka-Munk modeling of CFA RGB filter primaries is used for determining and adjusting the luminance contrast between CFA subpixels. In one example, solid areas of R, G, and B filter ink were inkjet-printed at defined default ink concentrations on an electrophoretic black-and-white (B&W) panel, and the spectral reflectance of each filter primary colored area were measured as (ρ_{R,WS(λ)}, ρ_{G,WS(λ)}, ρ_{B,WS(λ)}) with the B&W panel switched to a white state (WS) then measured again as (ρ_{R,DS(λ)}, ρ_{G,DS(λ)}, ρ_{B,DS(λ)}) with the B&W panel switched to a black or dark state (DS). The measurements were taken with a Konica-Minolta CM 3700a spectrophotometer in hemispherical-diffuse geometry, specular included. Measuring the spectral reflectance of blank panel areas switched to WS then measuring them again when switched to DS provided the reference spectral reflectance ρ_{WS(λ)} and ρ_{DS(λ)} necessary for the Kubelka-Munk calculations. From the four measurements—filter primary on WS and DS, and blank reference WS and DS—the spectral coefficients of scatter (S_{R}(λ), S_{G}(λ), S_{B}(λ)) and absorption (K_{R}(λ), K_{G}(λ), K_{B}(λ)) were calculated for a set of wavelengths (380, 10, 730) nm using the solutions of the Kubelka-Munk equations for the translucent case [Georg A. Klein, Industrial Color Physics, Springer (2010), chapter 5.3]:

| | |
|---|---|
| ${a}_{Q} = \frac{( 1 + {ρ}_{WS} \cdot {ρ}_{Q , WS} ) \cdot ( {ρ}_{Q , DS} - {ρ}_{DS} ) - ( 1 + {ρ}_{DS} \cdot {ρ}_{Q , DS} ) ( {ρ}_{Q , WS} - {ρ}_{WS} )}{2 ( {ρ}_{WS} \cdot {ρ}_{WS} - {ρ}_{DS} \cdot {ρ}_{DS} )}$ | (1) |
| ${b}_{Q} = \sqrt{{a}_{Q}^{2} - 1}$ | |
| ${S}_{Q} = \frac{1}{{b}_{Q}} arc coth ( \frac{1 - {a}_{Q} \cdot {R}_{x} + ( {R}_{x} - {a}_{Q} ) \cdot {R}_{Q , x}}{{b}_{Q} \cdot ( {R}_{Q , x} - {R}_{x} )} )$ | |
| K_{Q} = (a_{Q} − 1)S_{Q} | |
| x = (WS, DS), Q = (R, G, B) | |

Using the spectral coefficients of scatter and absorption thus determined, the spectral reflectance ρ_{Q}(c_{Q},d_{Q}) of each filter primary as a function of filter ink concentration c_{Q} and ink layer thickness d on a background panel switched to WS or DS can be predicted as follows:

| | |
|---|---|
| a_{Q} = (K_{Q} + S_{Q})/S_{Q} | (2) |
| ${k}_{Q} = {b}_{Q} {S}_{Q} = \sqrt{{K}_{Q} ( {K}_{Q} + 2 {S}_{Q} )}$ | |
| ${ρ}_{Q} ( {c}_{Q} , d ) = {c}_{Q} \frac{1 - {ρ}_{x} ( {a}_{Q} - {b}_{Q} coth ( {k}_{Q} {d}_{Q} ) )}{{a}_{Q} - {ρ}_{x} + {b}_{Q} coth ( {k}_{Q} {d}_{Q} )}$ | |
| x = (WS, DS), Q = (R, G, B) | |

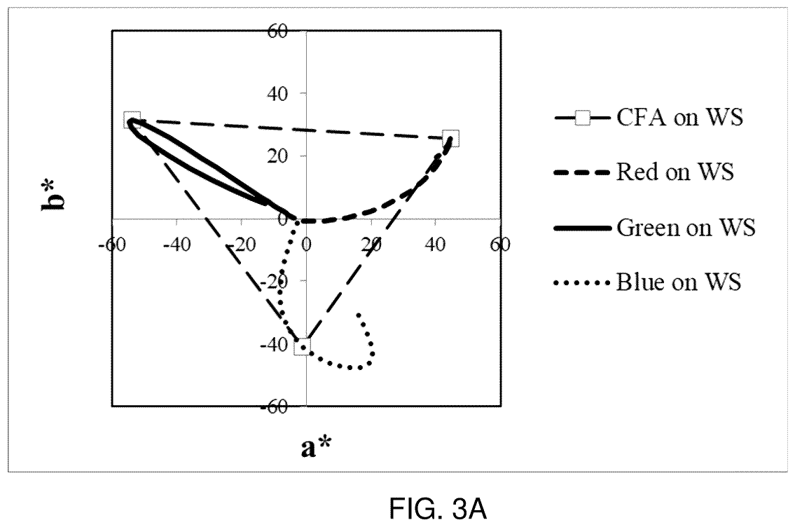

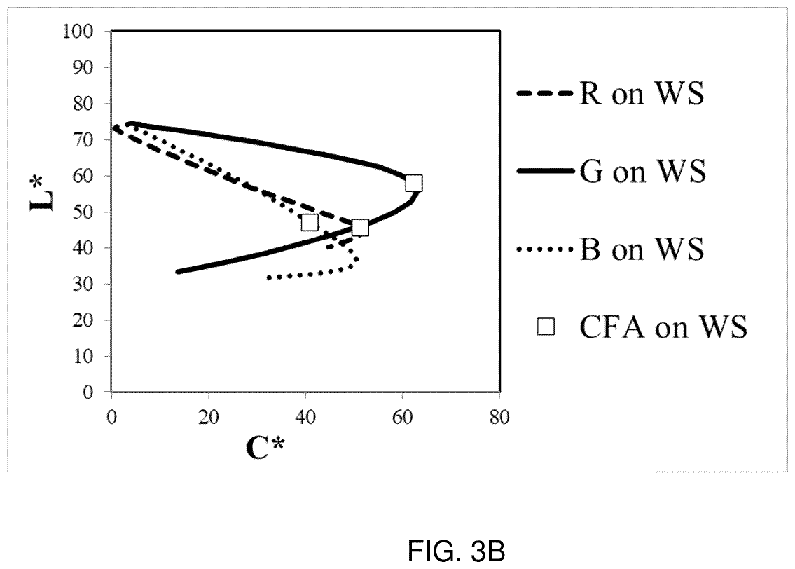

FIGS. 3A and 3B show CIELAB colors reflected by the CFA RGB primaries in a b* vs. a* diagram (FIG. 3A) and a lightness L* vs. chroma C* diagram (FIG. 3B) as function of CFA print ink concentration. The squares in the diagrams correspond to a default equal ink laydown of equal amounts for the R, G, and B filters.

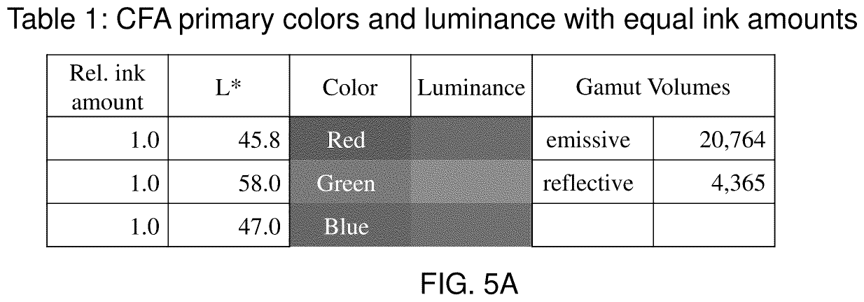

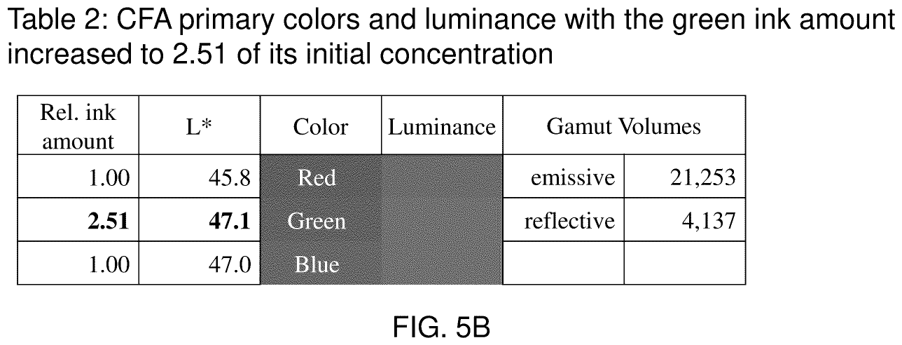

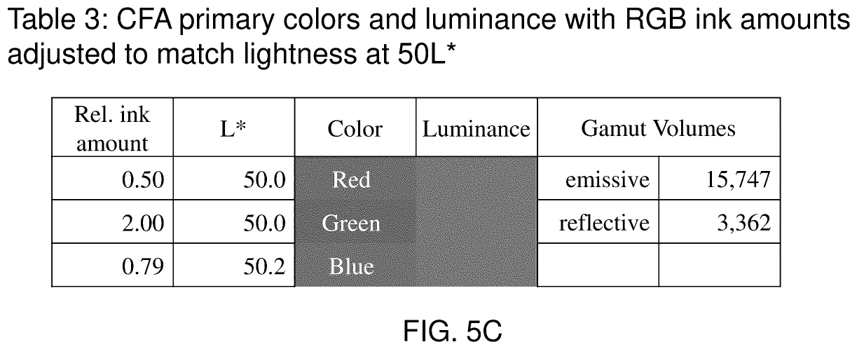

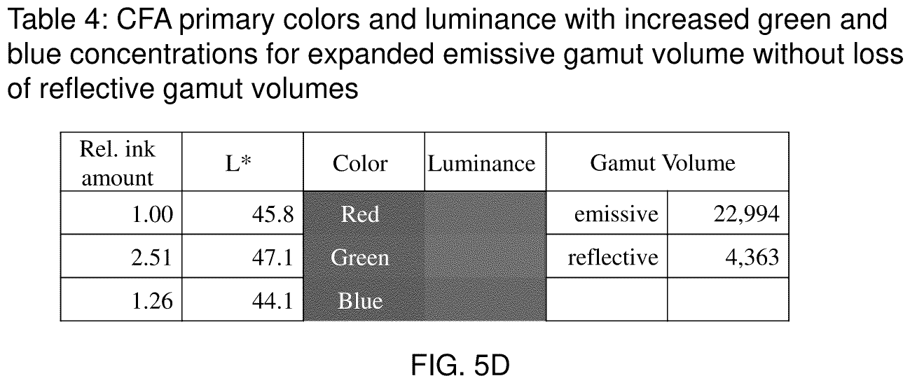

The L* vs. C* diagram (FIG. 3B) shows that the green filter primary is significantly lighter than the red and blue filter primaries. Table 1 (FIG. 5A) provides luminance data for the default ink laydown of equal amounts for the R, G, and B filters. The green primary had a lightness of 58 L*, and the red and blue primaries had a lightless of 45.8 L* and 47 L*, respectively. Lightness differences between CFA primaries of 10 L* and greater correspond to a luminance contrast of at least 1.6, which results in disturbing visible diagonal texture lines, as shown in FIGS. 2A and 2B. These figures show a CFA display with a Bayer-like filter arrangement with staggered RGB subpixels. FIG. 2A shows the subpixel arrangement of the CFA, and FIG. 2B shows the reflected luminance. As shown in FIG. 2A, the green subpixels were significantly lighter than the red and blue subpixels, leading to a luminance difference between the CFA primaries that is visible as texture of diagonal stripes.

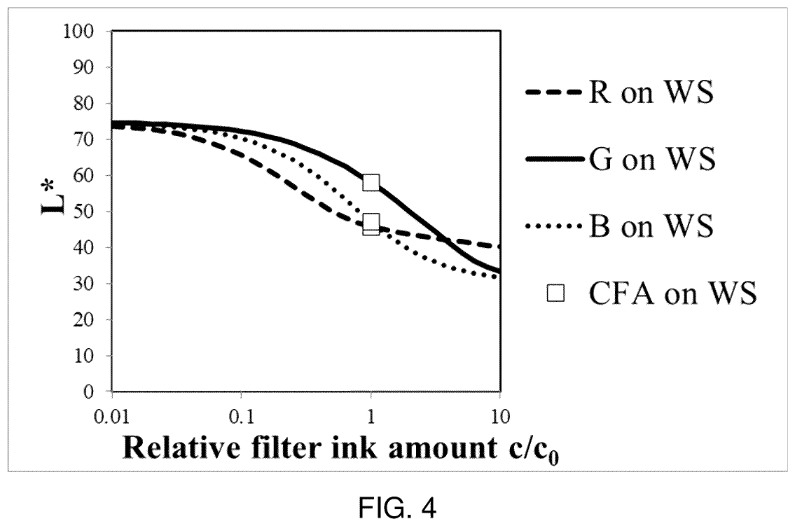

The solid lines in FIGS. 3A and 3B show the results of the Kubelka-Munk calculations in Equation (2), namely how the lightness, hue angle, and chroma (L*, h, and C*) of each filter primary change with the CFA print ink concentration relative to the default amount. The concentration dependence of filter lightness in reflection on WS relative to the default concentration co is shown in FIG. 4. The squares in the diagrams indicate the default equal ink amounts for R, G, and B.

In order to match the reflected luminance or lightness of the three filter primaries, the concentration of the filter inks can be increased until the L* of each match. The amount of change can be determined from the concentration dependence of L* shown in FIG. 4. There are different ways of matching the L* of the filter primaries, e.g., increasing the concentration of the green ink and/or decreasing the concentrations of the red and blue inks. Because this will also result in a change of hue angle and chroma as shown in 3A, the CIELAB color gamut volume in the reflective mode should be taken into account. If front lighting is present, the gamut volume in emissive mode should also be taken into account. This is illustrated in the following examples:

### Example 1

In the first example, only the concentration of the green filter ink is increased by a factor of 2.51, while the red and blue inks remain unchanged. This lowers the lightness of the green primary subpixels from 58 L* to 47.1 L* as shown in Table 2 (FIG. 5B). Compared to the initial filter primaries in Table 1, the darker green primary slightly improves gamut volume in emissive mode (frontlight on), but decreases in reflective mode (frontlight off).

### Example 2

In the second example, the concentration of the green filter ink is increased by a factor of 2, and the amounts of red and blue ink are decreased by a factor of 0.5 and 0.79, respectively. This matches the lightness of all three primary subpixels at about 50 L*, which will eliminate the texture associated with the CFA pattern, see Table 3 (FIG. 5C). However, compared to the initial filter primaries in Table 1, gamut volumes in both the emissive mode (frontlight on) and reflective mode (frontlight off) are decreased. Making the CFA primaries lighter is akin to mixing more white to the primary colors, which leads to lighter, more desaturated colors with an overall reduced gamut volume.

### Example 3

The third example with closely matched filter primaries and improved emissive and reflective gamut volume is shown in Table 4 (FIG. 5D). In addition to increasing the amount of green filter ink by a factor of 2.51, the amount of blue ink is also increased by a factor of 1.26 to change its hue angle to from cyan to blue for a better emissive gamut volume without loss of reflective gamut volume.

Kubelka-Munk measurements and models can thus be utilized in equalizing luminance or lightness (L*) between in inkjet-printed CFA subpixels by adjusting the amount of ink printed for each filter. Leveling L* differences between CFA primaries removes a principal component of CFA texture, visible as horizontal, vertical or diagonal lines. The adjustment of filter lightness can also be used to improve the hue of primaries such as blue, which depends strongly on ink concentration. Methods of removing CFA texture in accordance with various embodiments of the invention are less costly and more feasible than increasing the subpixel resolution of displays and other known ways of reducing texture visibility.

It will be apparent to those skilled in the art that numerous changes and modifications of the specific embodiments of the invention described above are possible. Accordingly, the foregoing description is to be construed in an illustrative and not in a limitative sense, the invention being defined by the appended claims.

1. A color electro-optic display, comprising:
a layer of electro-optic material having a viewing side for facing a viewer;
a light-transmissive electrode on the viewing side of the layer of electro-optic material;
an array of pixel electrodes on a side on the layer of electro-optic material opposite to the viewing side, each of said pixel electrodes being independently addressable to apply a driving voltage to an adjacent portion of the layer of electro-optic material associated therewith to drive such portion of the electro-optic material between a first substantially white optical state and a second substantially black optical state at the viewing side of the electro-optic layer; and
a color filter array disposed on the viewing side of the layer of electro-optic material, said color filter array comprising an array of pixels, each of said pixels having at least three color filter elements, each of said at least three color filter elements having a different color, each color filter element being aligned with a different one of the pixel electrodes such that the color of any color filter element is visible to the viewer when the pixel electrode aligned with that color filter element drives an adjacent portion of the electro-optic material to the substantially white optical state, and wherein the color of any color filter element is not visible to the viewer when the pixel electrode aligned with that color filter element drives an adjacent portion of the electro-optic material to a substantially black optical state;
wherein the colors of the color filter elements in the color filter array have the same lightness or a lightness difference no greater than 10 L* to substantially eliminate visible color filter array texture patterns.

2. The color electro-optic display of claim 1, wherein the colors of the color filter elements in the color filter array have a luminance contrast of less than 1.6.

3. The color electro-optic display of claim 1, wherein the colors of the color filter elements in the color filter array are red, green, and blue.

4. The color electro-optic display of claim 1, wherein the colors of the color filter elements in the color filter array have lightness values between 45 L* and 55 L*.

5. The color electro-optic display of claim 1, wherein the layer of electro-optic material is monochrome.

6. The color electro-optic display of claim 1, wherein the layer of electro-optic material comprises an encapsulated electrophoretic medium.

7. The color electro-optic display of claim 6, wherein the encapsulated electrophoretic medium comprises an electrophoretic medium encapsulated in microcapsules or microcups.

8. The color electro-optic display of claim 1, wherein the layer of electro-optic material comprises charged pigment particles dispersed in a non-polar solvent.

9. The color electro-optic display of claim 8, wherein the charged pigment particles comprise black and white pigment particles.

10. The color electro-optic display of claim 1, wherein the layer of electro-optic material is bistable.

11. The color electro-optic display of claim 1, wherein the colors of the color filter elements each have a given ink concentration configured to provide the same lightness, wherein each ink concentration is determined utilizing a Kubelka-Munk model.

12. A method of constructing a color electro-optic display, comprising depositing a color filter array on an electro-optic display,
wherein the electro-optic display comprises: (a) a layer of electro-optic material having a viewing side for facing a viewer; (b) a light-transmissive electrode on the viewing side of the layer of electro-optic material; and (c) an array of pixel electrodes on a side on the layer of electro-optic material opposite to the viewing side, each of said pixel electrodes being independently addressable to apply a driving voltage to an adjacent portion of the layer of electro-optic material associated therewith to drive such portion of the electro-optic material between a first substantially white optical state and a second substantially black optical state at the viewing side of the electro-optic layer;
wherein the color filter array is deposited to the viewing side of the layer of electro-optic material, said color filter array comprising an array of pixels, each of said pixels having at least three color filter elements, each of said at least three color filter elements having a different color, each color filter element being aligned with a different one of the pixel electrodes such that the color of any color filter element is visible to the viewer when the pixel electrode aligned with that color filter element drives an adjacent portion of the electro-optic material to the substantially white optical state, and wherein the color of any color filter element is not visible to the viewer when the pixel electrode aligned with that color filter element drives an adjacent portion of the electro-optic material to a substantially black optical state, wherein the colors of the color filter elements in the color filter array have the same lightness or a lightness difference no greater than 10 L* to substantially eliminate visible color filter array texture patterns.

13. The method of claim 12, wherein the colors of the color filter elements in the color filter array have a luminance contrast of less than 1.6.

14. The method of claim 12, wherein the colors of the color filter elements in the color filter array are red, green, and blue.

15. The method of claim 12, wherein the colors of the color filter elements in the color filter array have lightness values between 45 L* and 55 L*.

16. The method of claim 12, wherein the layer of electro-optic material is monochrome.

17. The method of claim 12, wherein the layer of electro-optic material comprises an encapsulated electrophoretic medium.

18. The method of claim 17, wherein the encapsulated electrophoretic medium comprises an electrophoretic medium encapsulated in microcapsules or microcups.

19. The method of claim 12, wherein the layer of electro-optic material comprises charged pigment particles dispersed in a non-polar solvent.

20. The method of claim 19, wherein the charged pigment particles comprise black and white pigment particles.

21. The method of claim 12, wherein the layer of electro-optic material is bistable.

22. The method of claim 12, wherein the colors of the color filter elements each have a given ink concentration configured to provide the same lightness, wherein each ink concentration is determined utilizing a Kubelka-Munk model.
